(19) United States
(12) Patent Application Publication
(10) Pub. No.: US 2013/0193749 A1
(43) Pub. Date: Aug. 1, 2013

(54) VEHICLE AND POWER TRANSFER SYSTEM

(71) Applicants: Toru NAKAMURA, Toyota-shi (JP); Shinji ICHIKAWA, Toyota-shi (JP)

(72) Inventors: Toru NAKAMURA, Toyota-shi (JP); Shinji ICHIKAWA, Toyota-shi (JP)

(21) Appl. No.: 13/748,011

(22) Filed: Jan. 23, 2013

(30) Foreign Application Priority Data
Jan. 31, 2012 (JP) 2012-018120

(51) Int. Cl. H04B 5/00; B60L 1/00

(52) U.S. Cl. CPC H04B 5/0037; B60L 1/00
USPC 307/9.1; 307/104

(57) ABSTRACT

A vehicle that includes a power receiving portion that contactlessly receives electric power from a power transmitting portion provided outside the vehicle includes a floor panel that forms a bottom face of the vehicle; and a battery that is provided on a lower face of the floor panel. The power receiving portion is provided on the lower face of the floor panel. When an image of the power receiving portion is projected horizontally from a location that is horizontally spaced apart from the power receiving portion toward the battery, at least part of the image of the power receiving portion is projected onto the battery.

### INCORPORATION BY REFERENCE

The disclosure of Japanese Patent Application No. 2012-018120 filed on Jan. 31, 2012 including the specification, drawings and abstract is incorporated herein by reference in its entirety.

### BACKGROUND OF THE INVENTION

1. Field of the Invention

The invention relates to a vehicle and a power transfer system.

2. Description of Related Art

In recent years, hybrid vehicles, electric vehicles, and the like, that drive drive wheels with the use of electric power from a battery, or the like, become a focus of attention in consideration of an environment.

Particularly, in recent years, in the above-described electromotive vehicles equipped with a battery, wireless charging through which the battery is contactlessly chargeable without using a plug, or the like, becomes a focus of attention.

For example, a vehicle described in Japanese Patent Application Publication No. 2010-183810 (JP 2010-183810 A) includes a secondary resonance coil, a secondary coil and a secondary battery. A power transfer system includes an alternating-current power supply, a primary coil connected to the alternating-current power supply, and a primary resonance coil. The secondary resonance coil contactlessly receives electric power from the primary resonance coil.

When the vehicle described in JP 2010-183810 A receives electric power from the power transfer system, an electromagnetic field is formed around the secondary resonance coil.

At this time, if a high-strength electromagnetic field formed around the secondary resonance coil leaks to around the vehicle, a surrounding device may be influenced.

### SUMMARY OF THE INVENTION

The invention provides a vehicle that inhibits a leakage of a high-strength electromagnetic field to around the vehicle at the time of power transfer, and a power transfer system.

An aspect of the invention provides a vehicle that includes a power receiving portion that contactlessly receives electric power from a power transmitting portion provided outside the vehicle. The vehicle includes: a floor panel that forms a bottom face of the vehicle; and a battery that is provided on a lower face of the floor panel. The power receiving portion is provided on the lower face of the floor panel. When an image of the power receiving portion is projected horizontally toward the battery, at least part of the image of the power receiving portion is projected onto the battery.

In the vehicle, the battery may include a shield that is provided at a portion that faces the power receiving portion.

In the vehicle, the battery may be arranged adjacent to a forward side in a travel direction of the vehicle with respect to the power receiving portion. In the vehicle, the battery may be arranged adjacent to a rearward side in a travel direction of the vehicle with respect to the power receiving portion. In the vehicle, the battery may be arranged adjacent to a forward side and a rearward side in a travel direction of the vehicle with respect to the power receiving portion.

In the vehicle, the battery may be arranged at a location adjacent to the power receiving portion in a width direction of the vehicle. In the vehicle, the battery may be arranged at a location adjacent to the power receiving portion on one side in the width direction of the vehicle. Furthermore, the battery may be arranged at a location adjacent to the power receiving portion on both sides in the width direction of the vehicle.

In the vehicle, the battery may include: a front portion that is located adjacent to a forward side in a travel direction of the vehicle with respect to the power receiving portion; a rear portion that is arranged adjacent to a rearward side in the travel direction of the vehicle with respect to the power receiving portion; a first side portion that is provided at a location adjacent to the power receiving portion in a width direction of the vehicle and a second side portion that is provided on an opposite side of the power receiving portion to a side on which the first side portion is provided.

In the vehicle, the battery may be arranged such that a lower end portion of the battery is located vertically lower than a lower end portion of the power receiving portion.

In the vehicle, the battery may include a control unit, the battery may include a facing portion that faces the power receiving portion, and the control unit may be provided on an opposite side of the facing portion to a side on which the power receiving portion is provided.

The vehicle may further include: an under cover that passes through a region that is located vertically downward of the battery and the power receiving portion and that is provided so as to cover the battery and the power receiving portion; and a cooling device that cools the battery and the power receiving portion by supplying refrigerant to between the under cover and the floor panel.

In the vehicle, a difference between a natural frequency of the power transmitting portion and a natural frequency of the power receiving portion may be smaller than or equal to 10% of the natural frequency of the power receiving portion.

In the vehicle, the power receiving portion may receive electric power from the power transmitting portion through at least one of a magnetic field that is formed between the power receiving portion and the power transmitting portion and that oscillates at a predetermined frequency and an electric field that is formed between the power receiving portion and the power transmitting portion and that oscillates at the predetermined frequency. A coupling coefficient between the power receiving portion and the power transmitting portion may be smaller than or equal to 0.1.

Another aspect of the invention provides a power transfer system that includes: a power transmitting device that includes a power transmitting portion; and a vehicle that includes a power receiving portion that contactlessly receives electric power from the power transmitting portion. In the power transfer system, the vehicle includes: a floor panel that forms a bottom face of the vehicle; and a battery that is provided on a lower face of the floor panel. When an image of the power receiving portion is projected horizontally toward the battery, at least part of the image of the power receiving portion is projected onto the battery.

With the vehicle and the power transfer system according to the above aspects, it is possible to inhibit a leakage of a high-strength electromagnetic field to around the vehicle at the time of power transfer.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view that schematically shows a power receiving device, a power transmitting device and a power transfer system according to a first embodiment of the invention;

FIG. 2 is a schematic view that shows a simulation model of the power transfer system according to the first embodiment of the invention;

FIG. 3 is a graph that shows simulation results of the simulation model shown in FIG. 2;

FIG. 4 is a graph that shows the correlation between a power transfer efficiency and a frequency of current that is supplied to a resonance coil at the time when an air gap is changed in a state where a natural frequency is fixed in the simulation model shown in FIG. 2;

FIG. 5 is a graph that shows the correlation between a distance from a current source (magnetic current source) and a strength of an electromagnetic field in the simulation model shown in FIG. 2;

FIG. 6 is a side view of an electromotive vehicle according to the first embodiment;

FIG. 7 is a bottom view of the electromotive vehicle according to the first embodiment of the invention;

FIG. 8 is a perspective view that shows a floor panel, power receiving device and battery of the electromotive vehicle according to the first embodiment with part of the floor panel omitted;

FIG. 9 is an exploded perspective view of the power receiving device of the electromotive vehicle according to the first embodiment;

FIG. 10 is a bottom view of an electromotive vehicle according to a second embodiment of the invention;

FIG. 11 is a bottom view of an electromotive vehicle according to a third embodiment of the invention;

FIG. 12 is a bottom view of an electromotive vehicle according to a fourth embodiment of the invention;

FIG. 13 is a bottom view of an electromotive vehicle according to a fifth embodiment of the invention;

FIG. 14 is a bottom view of an electromotive vehicle according to a sixth embodiment of the invention; and

FIG. 15 is a bottom view of an electromotive vehicle according to a seventh embodiment of the invention.

### DETAILED DESCRIPTION OF EMBODIMENTS

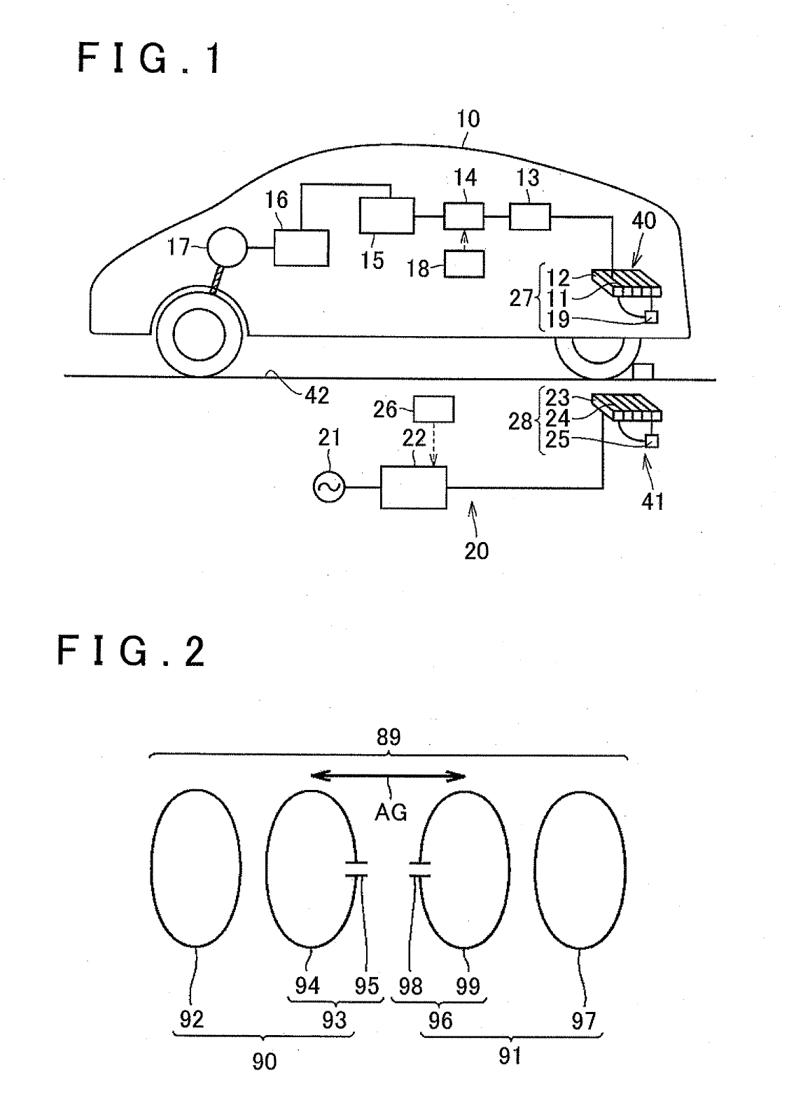

A power receiving device and a power transmitting device according to embodiments of the invention and a power transfer system that includes the power transmitting device and the power receiving device will be described with reference to FIG. 1 to FIG. 15, FIG. 1 is a schematic view that schematically shows the power receiving device, the power transmitting device and the power transfer system according to the first embodiment.

The power transfer system according to the first embodiment includes an electromotive vehicle 10 and an external power supply device 20. The electromotive vehicle 10 includes the power receiving device 40. The external power supply device 20 includes the power transmitting device 41. When the electromotive vehicle 10 is stopped at a predetermined position of a parking space 42 in which the power transmitting device 41 is provided, the power receiving device 40 of the electromotive vehicle 10 receives electric power from the power transmitting device 41.

A wheel block or a line that indicates a parking position and a parking area is provided in the parking space 42 so that the electromotive vehicle 10 is stopped at a predetermined position.

The external power supply device 20 includes a high-frequency power driver 22, a control unit 26 and the power transmitting device 41. The high-frequency power driver 22 is connected to an alternating-current power supply 21. The control unit 26 executes drive control over the high-frequency power driver 22, and the like. The power transmitting device 41 is connected to the high-frequency power driver 22. The power transmitting device 41 includes a power transmitting portion 28. The power transmitting portion 28 includes a ferrite core 23, a resonance coil 24 and a capacitor 25. The resonance coil 24 is wound around the ferrite core 23. The capacitor 25 is connected to the resonance coil 24. Note that the capacitor 25 is not an indispensable component. In addition, the ferrite core 23 is also not an indispensable component. When a hollow coil that is not wound around a ferrite core is used, the hollow coil is arranged such that the winding center line of the hollow coil is oriented in a vertical direction. The resonance coil 24 is connected to the high-frequency power driver 22.

The power transmitting portion 28 includes an electrical circuit that is formed of the inductance of the resonance coil 24, the stray capacitance of the resonance coil 24 and the capacitance of the capacitor 25.

The electromotive vehicle 10 includes the power receiving device 40, a rectifier 13, a DC/DC converter 14, a battery 15, a power control unit (PCU) 16, a motor unit 17 and a vehicle electronic control unit (ECU) 18. The rectifier 13 is connected to the power receiving device 40. The DC/DC converter 14 is connected to the rectifier 13. The battery 15 is connected to the DC/DC converter 14. The motor unit 17 is connected to the power control unit 16. The vehicle ECU 18 executes drive control over the DC/DC converter 14, the power control unit 16, and the like. The electromotive vehicle 10 according to the present embodiment is a hybrid vehicle that includes an engine (not shown). Instead, as long as the electromotive vehicle 10 is driven by a motor, the electromotive vehicle 10 may be an electric vehicle or a fuel cell vehicle.

The rectifier 13 is connected to a resonance coil 11, converts alternating current, which is supplied from the resonance coil 11, to direct current, and supplies the direct current to the DC/DC converter 14.

The DC/DC converter 14 adjusts the voltage of the direct current supplied from the rectifier 13, and supplies the adjusted voltage to the battery 15. The DC/DC converter 14 is not an indispensable component and may be omitted. In this case, by providing a matching transformer for matching impedance in the external power supply device 20 between the power transmitting device 41 and the high-frequency power driver 22, it is possible to substitute the matching transformer for the DC/DC converter 14.

The power control unit 16 includes a converter and an inverter. The converter is connected to the battery 15. The inverter is connected to the converter.

The converter adjusts (steps up) direct current that is supplied from the battery 15, and supplies the adjusted direct current to the inverter. The inverter converts the direct current, which is supplied from the converter, to alternating current, and supplies the alternating current to the motor unit 17.

For example, a three-phase alternating-current motor, or the like, is employed as the motor unit 17. The motor unit 17 is driven by alternating current that is supplied from the inverter of the power control unit 16.

When the electromotive vehicle 10 is a hybrid vehicle, the electromotive vehicle 10 further includes an engine. In addition, the motor unit 17 includes a motor generator that mainly functions as a generator and a motor generator that mainly functions as an electric motor.

The power receiving device 40 includes a power receiving portion 27. The power receiving portion 27 includes a ferrite core 12, the resonance coil 11 and a capacitor 19. The resonance coil 11 is wound around the outer periphery of the ferrite core 12. The capacitor 19 is connected to the resonance coil 11. In the power receiving portion 27 as well, the capacitor 19 is not an indispensable component. In addition, the ferrite core 12 is also not an indispensable component. When a hollow coil that is not wound around a ferrite core is used, the hollow coil is arranged such that the winding center line of the hollow coil is oriented in the vertical direction. The resonance coil 11 is connected to the rectifier 13.

The power receiving portion 27 includes the resonance coil 11 and the capacitor 19. The resonance coil 11 has a stray capacitance. The power receiving portion 27 has an electrical circuit that is formed of the inductance of the resonance coil 11 and the capacitances of the resonance coil 11 and capacitor 19. The capacitor 19 is not an indispensable component and may be omitted.

In the power transfer system according to the present embodiment, the difference between the natural frequency of the power transmitting portion 28 and the natural frequency of the power receiving portion 27 is smaller than or equal to 10% of the natural frequency of the power receiving portion 27 or power transmitting portion 28. By setting the natural frequency of each of the power transmitting portion 28 and the power receiving portion 27 within the above range, it is possible to increase the power transfer efficiency. On the other hand, when the difference in natural frequency is larger than 10% of the natural frequency of the power receiving portion 27 or power transmitting portion 28, the power transfer efficiency becomes lower than 10%, so there occurs an inconvenience, such as an increase in a charging time for charging the battery 15.

Here, the natural frequency of the power transmitting portion 28, in the case where no capacitor 25 is provided, means an oscillation frequency in the case where the electrical circuit formed of the inductance of the resonance coil 24 and the capacitance of the resonance coil 24 freely oscillates. In the case where the capacitor 25 is provided, the natural frequency of the power transmitting portion 28 means an oscillation frequency in the case where the electrical circuit formed of the capacitances of the resonance coil 24 and capacitor 25 and the inductance of the resonance coil 24 freely oscillates. In the above-described electrical circuits, the natural frequency at the time when braking force and electric resistance are set to zero or substantially zero is called the resonance frequency of the power transmitting portion 28.

Similarly, the natural frequency of the power receiving portion 27, in the case where no capacitor 19 is provided, means an oscillation frequency in the case where the electrical circuit formed of the inductance of the resonance coil 11 and the capacitance of the resonance coil 11 freely oscillates. In the case where the capacitor 19 is provided, the natural frequency of the power receiving portion 27 means an oscillation frequency in the case where the electrical circuit formed of the capacitances of the resonance coil 11 and capacitor 19 and the inductance of the resonance coil 11 freely oscillates. In the above-described electrical circuits, the natural frequency at the time when braking force and electric resistance are set to zero or substantially zero is called the resonance frequency of the power receiving portion 27.

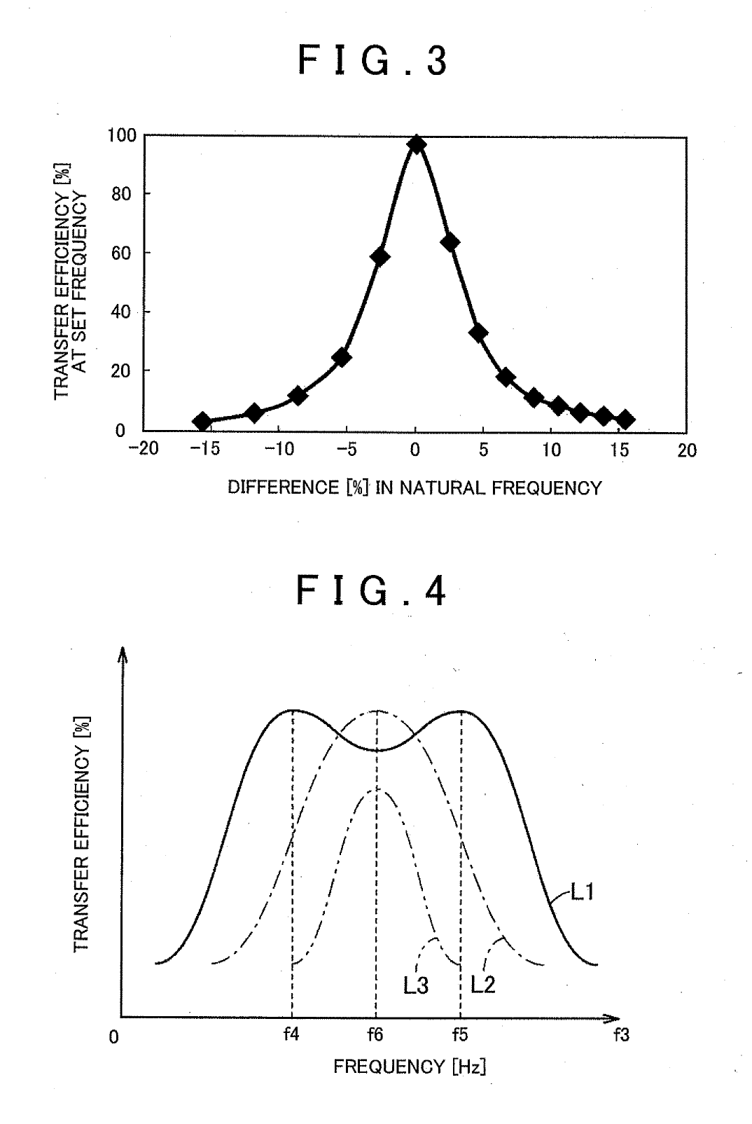

Results of simulation that analyzes the correlation between a difference in natural frequency and a power transfer efficiency will be described with reference to FIG. 2 and FIG. 3. FIG. 2 shows a simulation model of a power transfer system. The power transfer system 89 includes a power transmitting device 90 and a power receiving device 91. The power transmitting device 90 includes an electromagnetic induction coil 92 and a power transmitting portion 93. The power transmitting portion 93 includes a resonance coil 94 and a capacitor 95 provided in the resonance coil 94.

The power receiving device 91 includes a power receiving portion 96 and an electromagnetic induction coil 97. The power receiving portion 96 includes a resonance coil 99 and a capacitor 98 connected to the resonance coil 99.

The inductance of the resonance coil 94 is set to Lt, and the capacitance of the capacitor 95 is set to C1. The inductance of the resonance coil 99 is set to Lr, and the capacitance of the capacitor 98 is set to C2. When the parameters are set in this way, the natural frequency f1 of the power transmitting portion 93 is expressed by the following mathematical expression (1), and the natural frequency f2 of the power receiving portion 96 is expressed by the following mathematical expression (2).

f1=1{(2π(Lr×C1)^{1/2}} (1)

f1=1{(2π(Lr×C2)^{1/2}} (2)

Here, in the case where the inductance Lr and the capacitances C1 and C2 are fixed and only the inductance Lt is varied, the correlation between a difference in natural frequency between the power transmitting portion 93 and the power receiving portion 96 and a power transfer efficiency is shown in FIG. 3. Note that, in this simulation, a relative positional relationship between the resonance coil 94 and the resonance coil 99 is fixed, and, furthermore, the frequency of current that is supplied to the power transmitting portion 93 is constant.

As shown in FIG. 3, the abscissa axis represents a difference (%) in natural frequency, and the ordinate axis represents a transfer efficiency (%) at a set frequency. The difference (%) in natural frequency is expressed by the following mathematical expression (3).

Difference (%) in Natural Frequency={(f1−f2)/f2}×100 (3)

As is apparent from FIG. 3, when the difference (%) in natural frequency is ±0%, the power transfer efficiency is close to 100%. When the difference (%) in natural frequency is ±5%, the power transfer efficiency is 40%. When the difference (%) in natural frequency is ±10%, the power transfer efficiency is 10%. When the difference (%) in natural frequency is ±15%, the power transfer efficiency is 5%. That is, it is found that, by setting the natural frequency of each of the power transmitting portion and power receiving portion such that the absolute value of the difference (%) in natural frequency (difference in natural frequency) falls at or below 10% of the natural frequency of the power receiving portion 96, it is possible to increase the power transfer efficiency. Furthermore, it is found that, by setting the natural frequency of each of the power transmitting portion and power receiving portion such that the absolute value of the difference (%) in natural frequency is smaller than or equal to 5% of the natural frequency of the power receiving portion 96, it is possible to further increase the power transfer efficiency. Note that the electromagnetic field analyzation software application (MAC (trademark): produced by JSOL Corporation) is employed as a simulation software application.

Next, the operation of the power transfer system according to the present embodiment will be described. As shown in FIG. 1, alternating-current power is supplied from the high-frequency power driver 22 to the resonance coil 24. At this time, electric power is supplied such that the frequency of alternating current flowing through the resonance coil 24 becomes a predetermined frequency.

When current having the predetermined frequency flows through the resonance coil 24, an electromagnetic field that oscillates at the predetermined frequency is formed around the resonance coil 24.

The resonance coil 11 is arranged within a predetermined range from the resonance coil 24. The resonance coil 11 receives electric power from the electromagnetic field formed around the resonance coil 24.

In the present embodiment, a so-called helical coil is employed as each of the resonance coil 11 and the resonance coil 24. Therefore, a magnetic field that oscillates at the predetermined frequency is mainly formed around the resonance coil 24, and the resonance coil 11 receives electric power from the magnetic field.

Here, the magnetic field having the predetermined frequency, formed around the resonance coil 24, will be described. The “magnetic field having the predetermined frequency” typically correlates with the power transfer efficiency and the frequency of current that is supplied to the resonance coil 24. Then, first, the correlation between the power transfer efficiency and the frequency of current that is supplied to the resonance coil 24 will be described. The power transfer efficiency at the time when electric power is transferred from the resonance coil 24 to the resonance coil 11 varies depending on various factors, such as a distance between the resonance coil 24 and the resonance coil 11. For example, the natural frequency (resonance frequency) of the power transmitting portion 28 and power receiving portion 27 is set to f0, the frequency of current supplied to the resonance coil 24 is f3, and the air gap between the resonance coil 11 and the resonance coil 24 is set to AG.

FIG. 4 is a graph that shows the correlation between a power transfer efficiency and the frequency f3 of current that is supplied to the resonance coil 24 at the time when the air gap AG is varied in a state where the natural frequency f0 is fixed.

In the graph shown in FIG. 4, the abscissa axis represents the frequency f3 of current that is supplied to the resonance coil 24, and the ordinate axis represents a power transfer efficiency (%). An efficiency curve L1 schematically shows the correlation between a power transfer efficiency and the frequency f3 of current that is supplied to the resonance coil 24 when the air gap AG is small. As indicated by the efficiency curve L1, when the air gap AG is small, the peak of the power transfer efficiency appears at frequencies f4 and f5 (f4<f5). When the air gap AG is increased, two peaks at which the power transfer efficiency is high vary so as to approach each other. Then, as indicated by an efficiency curve L2, when the air gap AG is increased to be longer than a predetermined distance, the number of the peaks of the power transfer efficiency is one, the power transfer efficiency becomes a peak when the frequency of current that is supplied to the resonance coil 24 is f6. When the air gap AG is further increased from the state of the efficiency curve L2, the peak of the power transfer efficiency reduces as indicated by an efficiency curve L3.

For example, the following first and second methods are conceivable as a method of improving the power transfer efficiency. In the first method, by varying the capacitances of the capacitor 25 and capacitor 19 in accordance with the air gap AG while the frequency of current that is supplied to the resonance coil 24 shown in FIG. 1 is constant, the characteristic of power transfer efficiency between the power transmitting portion 28 and the power receiving portion 27 is varied. Specifically, the capacitances of the capacitor 25 and capacitor 19 are adjusted such that the power transfer efficiency becomes a peak in a state where the frequency of current that is supplied to the resonance coil 24 is constant. In this method, irrespective of the size of the air gap AG, the frequency of current flowing through the resonance coil 24 and the resonance coil 11 is constant. As a method of varying the characteristic of power transfer efficiency, a method of utilizing a matching transformer provided between the power transmitting device 41 and the high-frequency power driver 22, a method of utilizing the converter 14, or the like, may be employed.

In addition, in the second method, the frequency of current that is supplied to the resonance coil 24 is adjusted on the basis of the size of the air gap AG. For example, in FIG. 4, when the power transfer characteristic becomes the efficiency curve L1, current having the frequency f4 or the frequency f5 is supplied to the resonance coil 24. Then, when the frequency characteristic becomes the efficiency curve L2 or L3, current having the frequency f6 is supplied to the resonance coil 24. In this case, the frequency of current flowing through the resonance coil 24 and the resonance coil 11 is varied in accordance with the size of the air gap AG.

In the first method, the frequency of current flowing through the resonance coil 24 is a fixed constant frequency, and, in the second method, the frequency of current flowing through the resonance coil 24 is a frequency that appropriately varies with the air gap AG. Through the first method, the second method, or the like, current having the predetermined frequency set such that the power transfer efficiency is high is supplied to the resonance coil 24. When current having the predetermined frequency flows through the resonance coil 24, a magnetic field (electromagnetic field) that oscillates at the predetermined frequency is formed around the resonance coil 24. The power receiving portion 27 receives electric power from the power transmitting portion 28 through the magnetic field that is formed between the power receiving portion 27 and the power transmitting portion 28 and that oscillates at the predetermined frequency. Thus, the “magnetic field that oscillates at the predetermined frequency” is not necessarily a magnetic field having a fixed frequency. Note that, in the above-described embodiment, the frequency of current that is supplied to the resonance coil 24 is set by focusing on the air gap AG; however, the power transfer efficiency also varies on the basis of other factors, such as a deviation in the horizontal direction between the resonance coil 24 and the resonance coil 11, so the frequency of current that is supplied to the resonance coil 24 may possibly be adjusted on the basis of those other factors.

In the present embodiment, the description is made on the example in which a helical coil is employed as each resonance coil; however, when a meander line antenna, or the like, is employed as each resonance coil, current having a predetermined frequency flows through the resonance coil 24, and, therefore, an electric field having the predetermined frequency is formed around the resonance coil 24. Then, through the electric field, power is transferred between the power transmitting portion 28 and the power receiving portion 27.

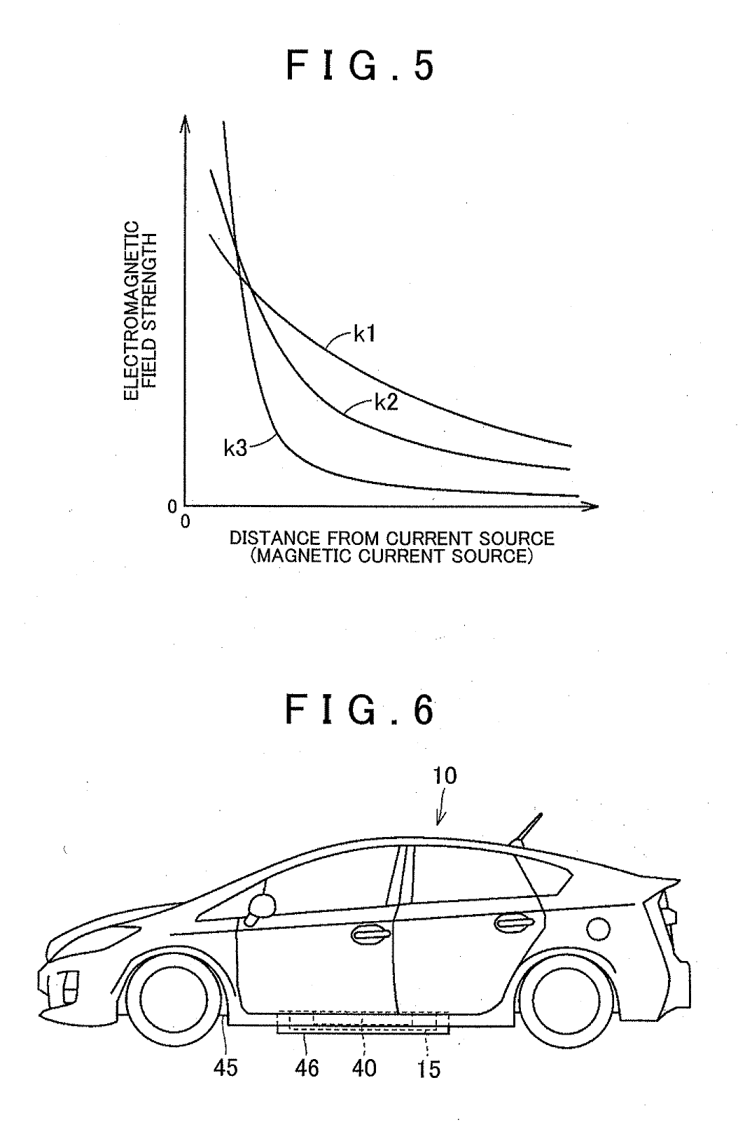

In the power transfer system according to the present embodiment, a near field (evanescent field) in which the static electromagnetic field of an electromagnetic field is dominant is utilized. By so doing, power transmitting and power receiving efficiencies are improved. FIG. 5 is a graph that shows the correlation between a distance from a current source or magnetic current source and a strength of an electromagnetic field. As shown in FIG. 5, the electromagnetic field includes three components. A curve k1 is a component inversely proportional to a distance from a wave source, and is referred to as radiation electromagnetic field. A curve k2 is a component inversely proportional to the square of a distance from a wave source, and is referred to as induction electromagnetic field. In addition, a curve k3 is a component inversely proportional to the cube of a distance from a wave source, and is referred to as static electromagnetic field. Where the wavelength of the electromagnetic field is λ, a distance at which the strengths of the radiation electromagnetic field, induction electromagnetic field and static electromagnetic field are substantially equal to one another may be expressed as λ/2π.

The static electromagnetic field is a region in which the strength of electromagnetic wave steeply reduces with a distance from a wave source. In the power transfer system according to the present embodiment, transfer of energy (electric power) is performed by utilizing the near field (evanescent field) in which the static electromagnetic field is dominant. That is, by resonating the power transmitting portion 28 and the power receiving portion 27 (for example, a pair of LC resonance coils) respectively having close natural frequencies in the near field in which the static electromagnetic field is dominant, energy (electric power) is transferred from the power transmitting portion 28 to the power receiving portion 27. This static electromagnetic field does not propagate energy to a far place. Thus, in comparison with an electromagnetic wave that transfers energy (electric power) by the radiation electromagnetic field that propagates energy to a far place, the resonance method is able to transmit electric power with a less energy loss.

In this way, in the power transfer system, by resonating the power transmitting portion and the power receiving portion through the electromagnetic field, electric power is contactlessly transmitted between the power transmitting portion and the power receiving portion. Then, a coupling coefficient κ between the power transmitting portion and the power receiving portion is, for example, smaller than or equal to about 0.3, and is desirably smaller than or equal to 0.1. Of course, a coupling coefficient κ that falls within the range of 0.1 to about 0.3 may also be employed. The coupling coefficient κ is not limited to such a value. Various values that cause high-efficiency power transfer may be used.

Coupling between the power transmitting portion 28 and the power receiving portion 27 in power transfer according to the present embodiment is, for example, called “magnetic resonance coupling”, “magnetic field resonance coupling”, “electromagnetic field resonance coupling” or “electric field resonance coupling”.

The electromagnetic field resonance coupling means coupling that includes the magnetic resonance coupling, the magnetic field resonance coupling and the electric field resonance coupling.

Coil-shaped antennas are employed as the resonance coil 24 of the power transmitting portion 28 and the resonance coil 11 of the power receiving portion 27, described in the specification. Therefore, the power transmitting portion 28 and the power receiving portion 27 are mainly coupled through a magnetic field, and the power transmitting portion 28 and the power receiving portion 27 are coupled through magnetic resonance or magnetic field resonance.

Note that an antenna, such as a meander line antenna, may be employed as each of the resonance coils 24 and 11. In this case, the power transmitting portion 28 and the power receiving portion 27 are mainly coupled through an electric field. At this time, the power transmitting portion 28 and the power receiving portion 27 are coupled through electric field resonance.

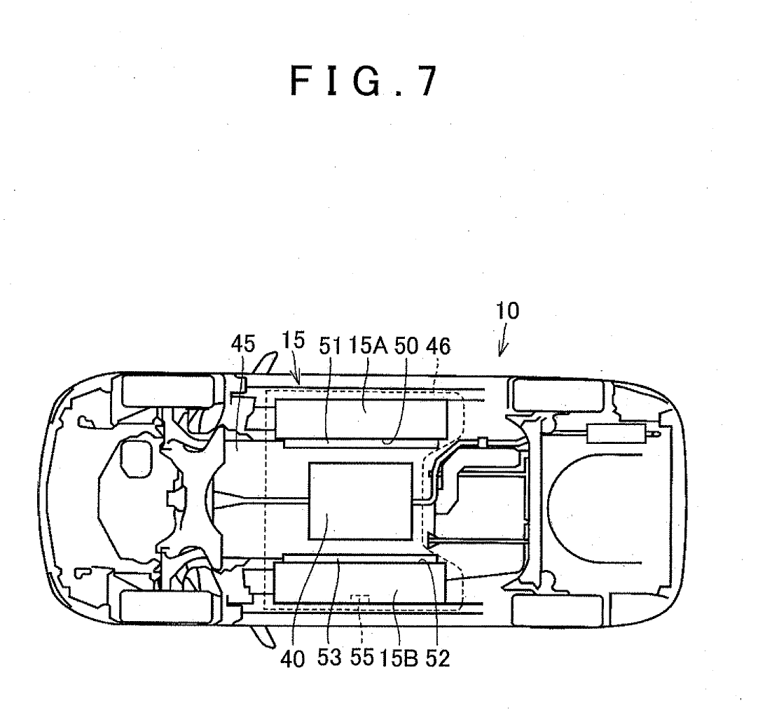

FIG. 6 is a side view of an electromotive vehicle 10. FIG. 7 is a bottom view of the electromotive vehicle 10. As shown in FIG. 6 and FIG. 7, the electromotive vehicle 10 includes a floor panel 45 that defines the bottom face of the electromotive vehicle 10. The floor panel 45 is a member that is arranged at the bottom face of the electromotive vehicle 10 and that partitions a vehicle outer portion and a vehicle inner portion from each other.

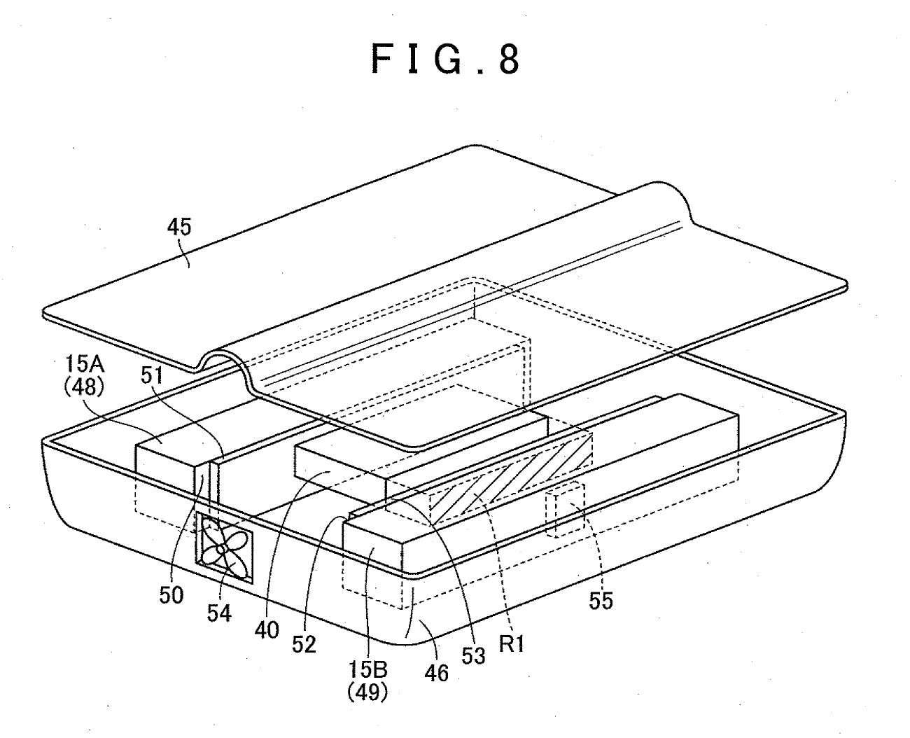

FIG. 8 is a perspective view that shows the floor panel 45, the power receiving device 40 and a battery 15 with part of the floor panel 45 omitted.

As shown in FIG. 8 and FIG. 7, the power receiving device 40, the battery 15, an under cover 46 and a cooling fan 54 are provided on the lower face of the floor panel 45. The under cover 46 is provided so as to cover the power receiving device 40 and the battery 15. The cooling fan 54 supplies cooling air (refrigerant) to between the under cover 46 and the floor panel 45 to cool the power receiving device 40 and the battery 15.

As shown in FIG. 7, the power receiving device 40 is arranged at the center portion in the longitudinal direction of the electromotive vehicle 10 and at the center portion in the width direction of the electromotive vehicle 10.

The arrangement of the power receiving device 40 will be specifically described. First, a shorter one of the distance between the front end portion of the electromotive vehicle 10, which is located adjacent to the forward side in the travel direction of the electromotive vehicle 10, and the power receiving device 40 and the distance between the rear end portion of the electromotive vehicle 10, which is located adjacent to the rearward side in the travel direction of the electromotive vehicle 10, and the power receiving device 40 is denoted by a distance LL1. Then, a longer one of the distance between the right-side portion of the electromotive vehicle 10 and the power receiving device 40 and the distance between the left-side portion of the electromotive vehicle 10 and the power receiving device 40 is denoted by a distance LL2. At this time, the power receiving device 40 is arranged such that the distance LL1 is longer than the distance LL2.

The battery 15 includes a battery 15A, a battery 15B and a battery ECU 55. The battery 15A is arranged so as to be spaced apart from the power receiving device 40 in the width direction of the electromotive vehicle 10. The battery 15B is arranged on the opposite side of the power receiving device 40 with respect to the side on which the battery 15A is arranged. The battery ECU 55 is provided inside the battery 15B. Therefore, the battery 15A, the power receiving device 40 and the battery 15B are arranged in the width direction of the electromotive vehicle 10.

The battery ECU 55 (battery electronic control unit) manages the battery 15. A signal that is required to manage the battery 15 is input to the battery ECU 55. For example, a terminal voltage from a voltage sensor (not shown) installed between the terminals of the battery 15, a charge/discharge current of the battery 15 from a current sensor (not shown), a battery temperature from a temperature sensor (not shown) attached to the battery 15, and the like, are input to the battery ECU 55. The battery ECU 55, where necessary, outputs data relating to the state of the battery 15 to the vehicle ECU 18 via communication. In the battery ECU 55, in order to manage the battery 15, a state of charge (SOC) is also computed on the basis of an accumulated value of the charge/discharge current detected by the current sensor.

The battery 15A includes a case 48 and an electromagnetic shield 51. The case 48 accommodates a plurality of secondary batteries. The electromagnetic shield 51 is provided on a facing surface 50 that faces the power receiving device 40 among the peripheral surfaces of the case 48.

The battery 1513 includes a case 49 and an electromagnetic shield 53. The case 49 accommodates a plurality of secondary batteries. The electromagnetic shield 53 is provided on a facing surface 52 that faces the power receiving device 40 among the peripheral surfaces of the case 49.

As shown in FIG. 8, the lower end portions of the battery 15A and battery 15B are located vertically lower than the lower end portion of the power receiving device 40. In addition, the upper end portions of the battery 15A and battery 15B are located vertically higher than the upper end portion of the power receiving device 40.

As shown in FIG. 8 and FIG. 7, the end portions of the battery 15A and battery 15B, which are located adjacent to the forward side in the travel direction of the electromotive vehicle 10, are located closer to the forward side in the travel direction of the electromotive vehicle 10 than the front end portion of the power receiving device 40, which is located adjacent to the forward side in the travel direction of the electromotive vehicle 10.

Similarly, the end portions of the battery 15A and battery 15B, which are located adjacent to the rearward side in the travel direction of the electromotive vehicle 10, are located closer to the rearward side in the travel direction of the electromotive vehicle 10 than the end portion of the power receiving device 40, which is located adjacent to the rearward side in the travel direction of the electromotive vehicle 10.

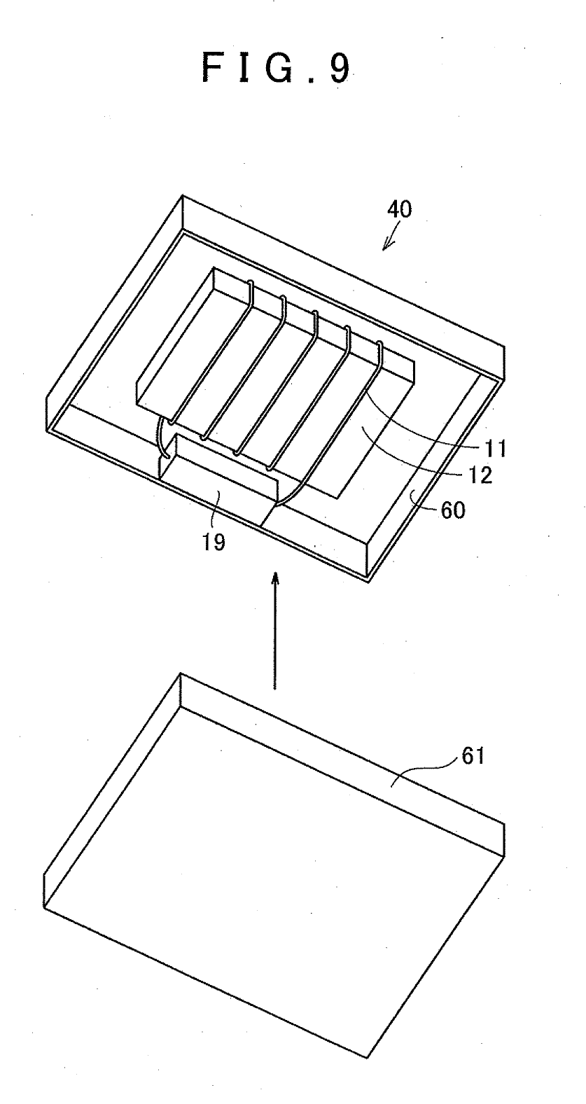

FIG. 9 is an exploded perspective view of the power receiving device 40. As shown in FIG. 9, the power receiving device 40 includes a shield case 60, a lid portion 61, the ferrite core 12 and the resonance coil 11. The shield case 60 is open downward. The lid portion 61 closes the opening of the shield case 60. The ferrite core 12 is provided inside the shield case 60. The resonance coil 11 is wound around the ferrite core 12.

As shown in FIG. 8, when an image of the power receiving device 40 is projected horizontally from a location that is horizontally spaced apart from the power receiving device 40 toward the battery 15A, the image of the power receiving device 40 is projected onto the battery 15B. Specifically, a projected portion R1 is a projected portion at the time when the image of the power receiving device 40 is projected horizontally onto the battery 15B. Similarly, when the image of the power receiving device 40 is projected horizontally from a location that is horizontally spaced apart from the power receiving device 40 toward the battery 15B, the image of the power receiving device 40 is projected onto the battery 15A.

The lower end portions of the batteries 15A and 15B are located lower than the lower end portion of the power receiving device 40, so a leakage of an electromagnetic field, which is formed around the power receiving device 40, toward an outside is inhibited.

The front end portions of the batteries 15A and 15B are located closer to the forward side in the travel direction than the front end portion of the power receiving device 40, and the rear end portions of the batteries 15A and 15B are located closer to the rearward side in the travel direction than the rear end portion of the power receiving device 40, so a leakage of an electromagnetic field, which is formed around the power receiving device 40, toward an outside is inhibited.

In the first embodiment, when the image of the power receiving device 40 is projected horizontally from a location that is horizontally spaced apart from the power receiving device 40 in the width direction of the electromotive vehicle 10, the projected portion of the power receiving device 40 completely falls within the battery 15A or 15B. Instead, the batteries 15A and 15B may be arranged such that part of the projected portion of the power receiving device 40 falls within the battery 15A or 15B. Even when part of the image of the power receiving device 40 is projected onto the battery 15A or 15B, it is possible to inhibit a leakage of an electromagnetic field to around the electromotive vehicle 10.

The electromagnetic shields 51 and 53 are respectively provided on the facing surfaces 50 and 52 of the batteries 15A and 15B, so it is possible to inhibit a leakage of an electromagnetic field, which is formed around the power receiving device 40, to around the electromotive vehicle 10.

The under cover 46 passes below the power receiving device 40, the battery 15A and the battery 15B, and is provided on the floor panel 45 so as to cover the power receiving device 40, the battery 15A and the battery 158. Therefore, for example, when the electromotive vehicle 10 throws up a small stone, or the like, on a road surface while travelling, it is possible to inhibit a thrown small stone, or the like, from hitting the power receiving device 40 or the battery 15. In the first embodiment, the under cover 46 includes side wall portions, a front wall portion and a rear wall portion. The side wall portions respectively pass by the sides of the battery 15A and battery 1513 and are fixed to the floor panel 45. The front wall portion passes by the front sides of the battery 15A and battery 15B and is fixed to the floor panel 45. The rear wall portion passes by the rear sides of the battery 15A and battery 15B and is fixed to the floor panel 45. The shape of each of the side wall portions, front wall portion and rear wall portion includes a curved shape.

By so doing, the battery 15A, the battery 15B and the power receiving device 40 are covered with the under cover 46. The cooling fan 54 is provided in a hole that is formed in the under cover 46. The cooling fan 54 supplies air outside the electromotive vehicle 10 into the under cover 46.

The power receiving device 40 and the battery 15 are cooled by cooling air from the cooling fan 54. By so doing, it is possible to inhibit high temperature conditions of the power receiving device 40 and the battery 15.

The battery ECU 55 is provided in the battery 1513. The battery ECU 55 is provided on the opposite side of the facing surface 52 to the side on which the power receiving device 40 is provided. Therefore, when an electromagnetic field is formed around the power receiving device 40 at the time of power transfer, it is possible to inhibit the battery ECU 55 from being influenced by the electromagnetic field.

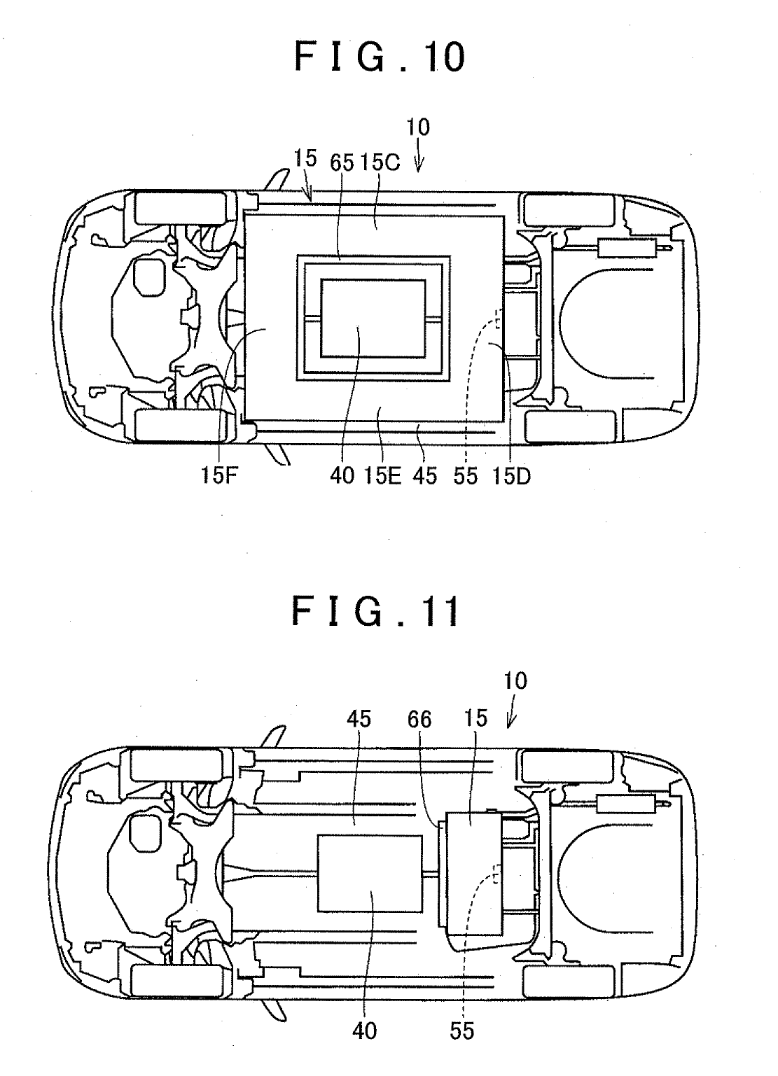

The electromotive vehicle 10 according to the second embodiment will be described with reference to FIG. 10. In components shown in FIG. 10, like reference numerals denote the same or corresponding components to those shown in FIG. 1 to FIG. 9, and the description thereof may be omitted where appropriate.

FIG. 10 is a bottom view of the electromotive vehicle 10 according to the second embodiment. As shown in FIG. 10, the battery 15 is formed in a square annular shape so as to surround the power receiving device 40. Specifically, the battery 15 includes a front portion 15F, a side portion 15C, a rear portion 15D and a side portion 15E.

The front portion 15F is arranged adjacent to the forward side in the travel direction of the electromotive vehicle 10 with respect to the power receiving device 40, and the side portion 15C is arranged at a location adjacent to the power receiving device 40 in the width direction of the electromotive vehicle 10. The rear portion 15D is arranged adjacent to the rearward side in the travel direction of the electromotive vehicle 10 with respect to the power receiving device 40, and the side portion 15E is arranged at a location adjacent to the power receiving device 40 in the width direction of the electromotive vehicle 10.

Therefore, when the image of the power receiving device 40 is projected horizontally from the forward side in the travel direction of the electromotive vehicle 10 with respect to the power receiving device 40, the projected portion of the power receiving device 40 is projected onto the rear portion 15D. When the image of the power receiving device 40 is projected horizontally from the rearward side in the travel direction of the electromotive vehicle 10 with respect to the power receiving device 40, the projected portion of the power receiving device 40 is projected onto the front portion 15F.

Similarly, when the image of the power receiving device 40 is projected from a location that is spaced apart from the power receiving device 40 in the width direction of the electromotive vehicle 10, the projected portion of the power receiving device 40 is projected onto the side portion 15C or the side portion 15E.

Therefore, even when an electromagnetic field is formed around the power receiving device 40 at the time of power transfer, a leakage of the electromagnetic field to around the electromotive vehicle 10 is inhibited.

The battery 15 is formed in a square annular shape, and the inner periphery of the battery 15 faces the power receiving device 40. The battery 15 includes an electromagnetic shield 65 provided on the inner periphery facing the power receiving device 40. By so doing, a leakage of an electromagnetic field to around the electromotive vehicle 10 is inhibited.

The battery ECU 55 is provided on the opposite side of the inner periphery of the battery 15 to the side on which the power receiving device 40 is provided, and is arranged at the outer peripheral side of the battery 15.

In the second embodiment as well, the lower end portion of the battery 15 is located lower than the lower end portion of the power receiving device 40, and the upper end portion of the battery 15 is located higher than the upper end portion of the power receiving device 40.

The electromotive vehicle 10 according to the third embodiment will be described with reference to FIG. 11. In components shown in FIG. 11, like reference numerals denote the same or corresponding components to those shown in FIG. 1 to FIG. 10, and the description thereof may be omitted where appropriate.

FIG. 11 is a bottom view of the electromotive vehicle 10 according to the third embodiment. As shown in FIG. 11, the battery 15 is arranged adjacent to the rearward side in the travel direction of the electromotive vehicle 10 with respect to the power receiving device 40.

When the image of the power receiving device 40 is projected horizontally from a portion that is located adjacent to the forward side in the travel direction of the electromotive vehicle 10 with respect to the power receiving device 40, the image of the power receiving device 40 is projected onto the battery 15.

Therefore, it is possible to inhibit a leakage of an electromagnetic field, which is formed around the power receiving device 40 at the time of power transfer, from the rearward side of the electromotive vehicle 10.

The battery 15 includes an electromagnetic shield 66. The electromagnetic shield 66 is provided on a facing surface that faces the power receiving device 40 among the peripheral surfaces of the battery 15. By so doing, a leakage of an electromagnetic field, which is formed around the power receiving device 40, toward the rearward side of the electromotive vehicle 10 is inhibited.

The battery ECU 55 provided in the battery 15 is provided on the opposite side of the facing surface, on which the electromagnetic shield 66 is provided, to the side on which the power receiving device 40 is provided. Therefore, the influence of an electromagnetic field, which is formed around the power receiving device 40, on the battery ECU 55 is inhibited.

In the third embodiment as well, the lower end portion of the battery 15 is located lower than the lower end portion of the power receiving device 40, and the upper end portion of the battery 15 is located higher than the upper end portion of the power receiving device 40.

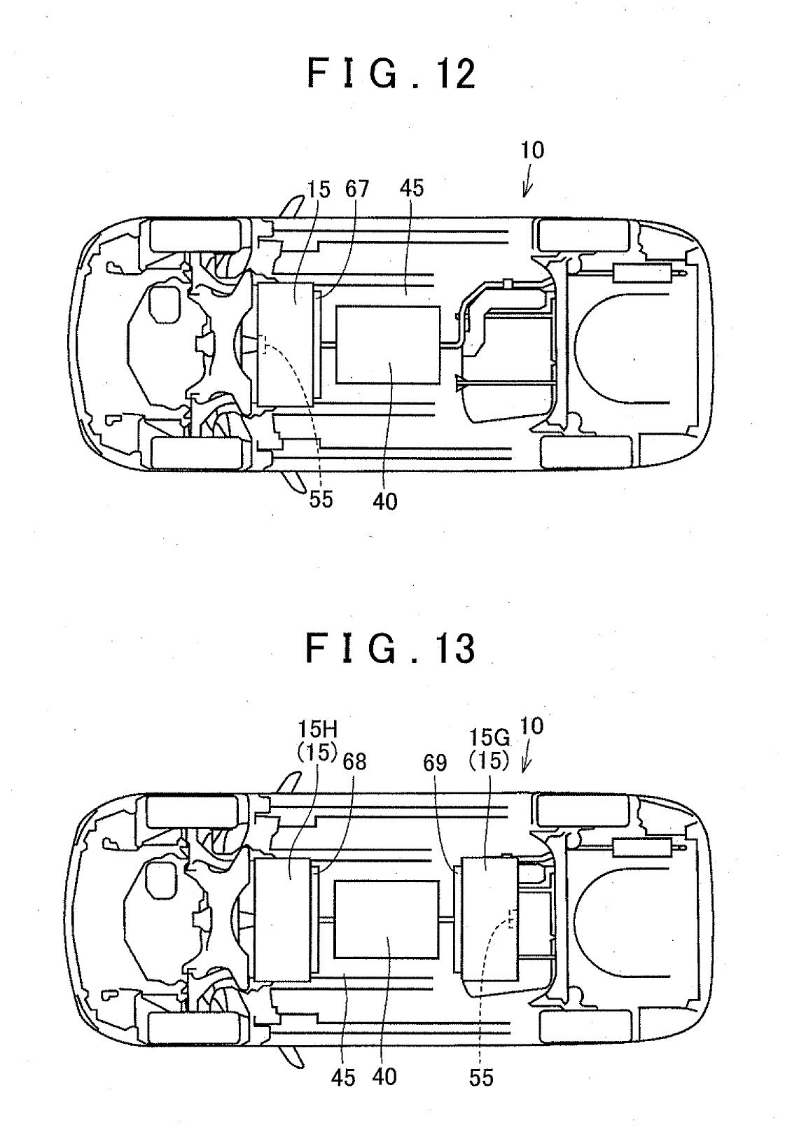

The electromotive vehicle 10 according to the fourth embodiment will be described with reference to FIG. 12. In components shown in FIG. 12, like reference numerals denote the same or corresponding components to those shown in FIG. 1 to FIG. 11, and the description thereof may be omitted where appropriate.

FIG. 12 is a bottom view of the electromotive vehicle 10 according to the fourth embodiment. As shown in FIG. 12, the battery 15 is arranged adjacent to the forward side in the travel direction of the electromotive vehicle 10 with respect to the power receiving device 40.

When the image of the power receiving device 40 is projected horizontally from the rearward side in the travel direction of the electromotive vehicle 10 with respect to the power receiving device 40, the image of the power receiving device 40 is projected onto the battery 15. Therefore, it is possible to inhibit a leakage of an electromagnetic field, which is formed around the power receiving device 40 at the time of power transfer, from the forward side in the travel direction of the electromotive vehicle 10 to around the electromotive vehicle 10. The battery 15 is arranged adjacent to the forward side in the travel direction with respect to the power receiving device 40. Therefore, when the electromotive vehicle 10 is travelling, it is possible to inhibit a blockage of travel wind due to the power receiving device 40, so it is possible to appropriately cool the battery 15.

The battery 15 includes an electromagnetic shield 67. The electromagnetic shield 67 is provided on a facing surface that faces the power receiving device 40. By so doing, a leakage of an electromagnetic field from the forward side in the travel direction of the electromotive vehicle 10 is inhibited.

The electromotive vehicle 10 according to the fifth embodiment will be described with reference to FIG. 13. In components shown in FIG. 13, like reference numerals denote the same or corresponding components to those shown in FIG. 1 to FIG. 12, and the description thereof may be omitted where appropriate. FIG. 13 is a bottom view of the electromotive vehicle 10 according to the fifth embodiment.

As shown in FIG. 13, the battery 15 includes a rear battery 15G and a front battery 15H. The rear battery 15G is arranged adjacent to the rearward side in the travel direction of the electromotive vehicle 10 with respect to the power receiving device 40. The front battery 15H is arranged adjacent to the forward side in the travel direction of the electromotive vehicle 10 with respect to the power receiving device 40.

When the image of the power receiving device 40 is projected horizontally from the forward side in the travel direction of the electromotive vehicle 10 with respect to the power receiving device 40, the image of the power receiving device 40 is projected onto the rear battery 15G. When the image of the power receiving device 40 is projected horizontally from the rearward side in the travel direction of the electromotive vehicle 10 with respect to the power receiving device 40, the image of the power receiving device 40 is projected onto the front battery 15H.

Therefore, it is possible to inhibit a leakage of an electromagnetic field, which is formed around the power receiving device 40 at the time of power transfer, from the forward side and the rearward side in the travel direction of the electromotive vehicle 10 to around the electromotive vehicle 10.

The front battery 15H includes an electromagnetic shield 68 that is provided on a facing surface that faces the power receiving device 40. The rear battery 15G includes an electromagnetic shield 69 that is provided on a facing surface that faces the power receiving device 40. Therefore, it is possible to inhibit a leakage of an electromagnetic field, which is formed around the power receiving device 40, from the forward side and the rearward side in the travel direction of the electromotive vehicle 10 to around the electromotive vehicle 10.

In the fifth embodiment as well, the lower end portions of the rear battery 15G and front battery 15H are located lower than the lower end portion of the power receiving device 40, and the upper end portions of the rear battery 15G and front battery 15H are located higher than the upper end portion of the power receiving device 40.

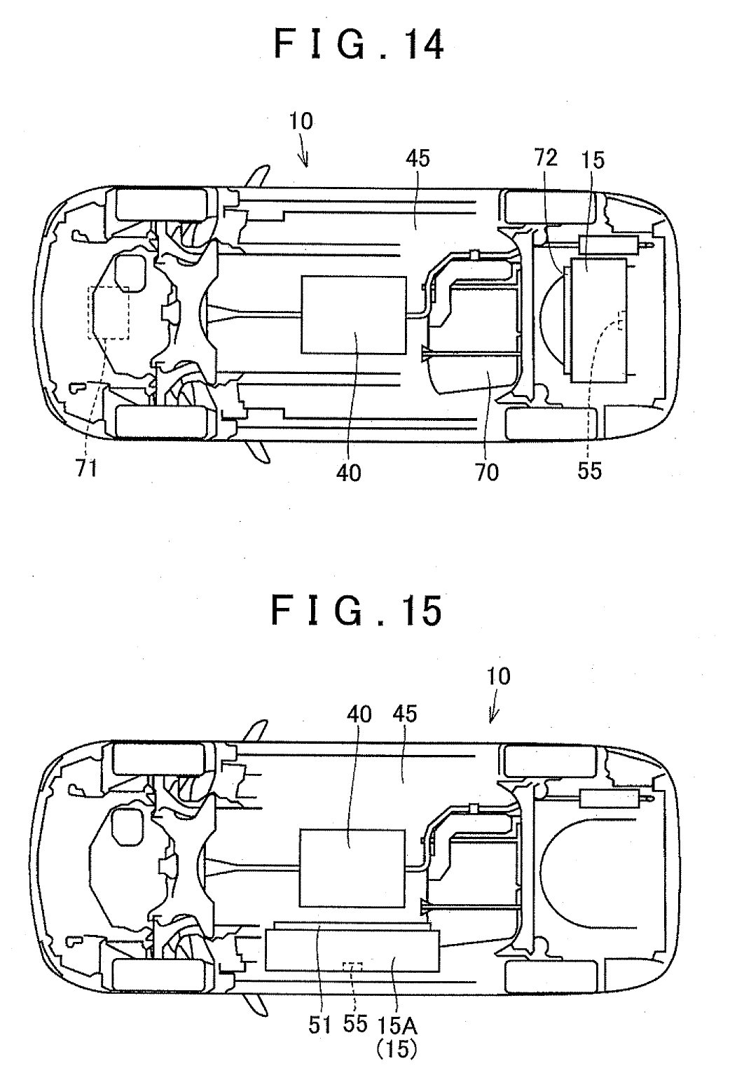

The electromotive vehicle 10 according to the sixth embodiment will be described with reference to FIG. 14. In components shown in FIG. 14, like reference numerals denote the same or corresponding components to those shown in FIG. 1 to FIG. 13, and the description thereof may be omitted where appropriate. FIG. 14 is a bottom view of the electromotive vehicle 10 according to the sixth embodiment.

The electromotive vehicle 10 according to the sixth embodiment is a hybrid vehicle, and includes an engine 71 and a fuel tank 70. The engine 71 is mounted in an engine compartment. The fuel tank 70 stores fuel that is supplied to the engine 71.

As shown in FIG. 14, the electromotive vehicle 10 includes the fuel tank 70 that is provided on the lower face of the floor panel 45. The fuel tank 70 is arranged adjacent to the rearward side in the travel direction of the electromotive vehicle 10 with respect to the power receiving device 40. The battery 15 is arranged closer to the rearward side in the travel direction of the electromotive vehicle 10 than the fuel tank 70.

When the image of the power receiving device 40 is projected horizontally from the forward side in the travel direction of the electromotive vehicle 10 with respect to the power receiving device 40, the image of the power receiving device 40 is projected onto the battery 15. Therefore, a leakage of an electromagnetic field from the rearward side in the travel direction of the electromotive vehicle 10 to around the electromotive vehicle 10 is inhibited. Note that the battery 15 includes an electromagnetic shield 72 that is provided on a facing surface that faces the power receiving device 40.

The fuel tank 70 is provided between the battery 15 and the power receiving device 40. A certain clearance is provided between the battery 15 and the power receiving device 40. At the time of power transfer, the strength of electromagnetic field increases as a location approaches the power receiving device 40. By increasing the distance between the battery 15 and the power receiving device 40, it is possible to inhibit the battery 15 from being arranged within a region in which the strength of electromagnetic field is high, so it is possible to inhibit heating of the battery 15. In addition, it is possible to inhibit conversion of the energy of an electromagnetic field to heat, so it is possible to inhibit a decrease in power transfer efficiency.

FIG. 15 is a bottom view of the electromotive vehicle 10 according to the seventh embodiment of the invention. As shown in FIG. 15, the battery 15 is arranged at a location adjacent to the power receiving device 40 in the width direction of the electromotive vehicle 10. In components shown in FIG. 15, like reference numerals denote the same or corresponding components to those shown in FIG. 1 to FIG. 14, and the description thereof may be omitted where appropriate. In the embodiment shown in FIG. 15, the battery 15 is arranged adjacent to one of side portions of the electromotive vehicle 10 with respect to the power receiving device 40. In the seventh embodiment as well, when the image of the power receiving device 40 is projected horizontally from the other one of the side portions of the electromotive vehicle 10, the image of the power receiving device 40 is projected onto a facing surface of the battery 15, which faces the power receiving device 40. Therefore, it is possible to inhibit a leakage of an electromagnetic field, which is formed around the power receiving device 40 at the time of power transfer, from the one of the side portions of the electromotive vehicle 10 to around the electromotive vehicle 10.

The battery 15 includes an electromagnetic shield 51 that is provided on the facing surface that faces the power receiving device 40. The electromagnetic shield 51 inhibits a leakage of an electromagnetic field to around the electromotive vehicle 10.

The embodiments described above are illustrative and not restrictive in all respects. The scope of the invention is defined by not the description of the above embodiments but the appended claims. The scope of the invention is intended to encompass all modifications within the scope of the appended claims and equivalents thereof. The invention may be applied to a vehicle and a power transfer system.

What is claimed is:

1. A vehicle comprising:
a floor panel that forms a bottom face of the vehicle;
a battery that is provided on a lower face of the floor panel; and
a power receiving portion that contactlessly receives electric power from a power transmitting portion provided outside the vehicle and that is provided on the lower face of the floor panel, at least part of an image of the power receiving portion being projected onto the battery when the image of the power receiving portion is projected horizontally toward the battery.

2. The vehicle according to claim 1, wherein
the battery includes a shield that is provided at a portion that faces the power receiving portion.

3. The vehicle according to claim 1, wherein
the battery is arranged adjacent to a forward side in a travel direction of the vehicle with respect to the power receiving portion.

4. The vehicle according to claim 1, wherein
the battery is arranged adjacent to a rearward side in a travel direction of the vehicle with respect to the power receiving portion.

5. The vehicle according to claim 1, wherein
the battery is arranged adjacent to a forward side and a rearward side in a travel direction of the vehicle with respect to the power receiving portion.

6. The vehicle according to claim 1, wherein
the battery is arranged at a location adjacent to the power receiving portion in a width direction of the vehicle.

7. The vehicle according to claim 6, wherein
the battery is arranged at a location adjacent to the power receiving portion on one side in the width direction of the vehicle.

8. The vehicle according to claim 6, wherein
the battery is arranged at a location adjacent to the power receiving portion on both sides in the width direction of the vehicle.

9. The vehicle according to claim 1, wherein
the battery includes: a front portion that is located adjacent to a forward side in a travel direction of the vehicle with respect to the power receiving portion; a rear portion that is arranged adjacent to a rearward side in the travel direction of the vehicle with respect to the power receiving portion; a first side portion that is provided at a location adjacent to the power receiving portion in a width direction of the vehicle and a second side portion that is provided on an opposite side of the power receiving portion to a side on which the first side portion is provided.

10. The vehicle according to claim 1, wherein
the battery is arranged such that a lower end portion of the battery is located vertically lower than a lower end portion of the power receiving portion.

11. The vehicle according to claim 1, wherein
the battery includes a control unit, the battery includes a facing portion that faces the power receiving portion, and the control unit is provided on an opposite side of the facing portion to a side on which the power receiving portion is provided.

12. The vehicle according to claim 1, further comprising:
an under cover that passes through a region that is located vertically downward of the battery and the power receiving portion, the under cover being provided so as to cover the battery and the power receiving portion; and
a cooling device that cools the battery and the power receiving portion by supplying refrigerant to between the under cover and the floor panel.

13. The vehicle according to claim 1, wherein
a difference between a natural frequency of the power transmitting portion and a natural frequency of the power receiving portion is smaller than or equal to 10% of the natural frequency of the power receiving portion.

14. The vehicle according to claim 1, wherein
the power receiving portion receives electric power from the power transmitting portion through at least one of a magnetic field and an electric field, the magnetic field is formed between the power receiving portion and the power transmitting portion and oscillates at a predetermined frequency, and the electric field is formed between the power receiving portion and the power transmitting portion and oscillates at the predetermined frequency.

15. The vehicle according to claim 1, wherein
a coupling coefficient between the power receiving portion and the power transmitting portion is smaller than or equal to 0.1.

16. A power transfer system comprising:
a power transmitting device that includes a power transmitting portion; and
a vehicle that includes: a power receiving portion that contactlessly receives electric power from the power transmitting portion; a floor panel that forms a bottom face of the vehicle; and a battery that is provided on a lower face of the floor panel, at least part of an image of the power receiving portion being projected onto the battery when the image of the power receiving portion is projected horizontally toward the battery.
